(19) United States
(12) Patent Application Publication
(10) Pub. No.: US 2016/0012238 A1
(43) Pub. Date: Jan. 14, 2016

(54) A METHOD AND SYSTEM FOR PRIVACY-PRESERVING RECOMMENDATION TO RATING CONTRIBUTING USERS BASED ON MATRIX FACTORIZATION

(71) Applicant: THOMSON LICENSING, ISSY-LES-MOULINEAUX (FR)

(72) Inventors: Efstratios IOANNIDIS, Boston, MA (US); Ehud WEINSBERG, Menlo Park, CA (US); Nina Anne TAFT, San Francisco, CA (US); Marc JOYE, Belgium (BG); Valeria NIKOLAENKO, Stanford, CA (US)

(73) Assignee: Thomson Licensing

(21) Appl. No.: 14/771,659

(22) PCT Filed: May 1, 2014
(86) PCT No.: PCT/US2014/036359

§ 371 Date: Aug. 31, 2015

Related U.S. Application Data
(60) Provisional application No. 61/772,404, filed on Mar. 4, 2013.
(60) Provisional application No. 61/864,088, filed on Aug. 9, 2013.
(60) Provisional application No. 61/864,094, filed on Aug. 9, 2013.
(60) Provisional application No. 61/864,098, filed on Aug. 9, 2013.
(60) Provisional application No. 61/864,085, filed on Aug. 9, 2013.

(30) Foreign Application Priority Data
Dec. 19, 2013 (US) PCT/US2013/076353

(51) Int. Cl. G06F 21/60; H04L 9/00

(52) U.S. Cl. CPC G06F 21/602; H04L 9/008; H04L 2209/24

(57) ABSTRACT

A method includes: receiving a set of records, wherein each record in the set of records is received from a respective user and includes a set of tokens and a set of items, and wherein each record is kept secret from parties other than the respective user, receiving a recommendation request from a requesting user for a particular item, evaluating the set of records by using a garbled circuit based on matrix factorization, wherein the output of the garbled circuit includes a masked item profile for a particular item and a masked user profile for the requesting user, receiving an encrypted user profile from the requesting user, generating an encrypted recommendation for the particular item based on the encrypted user profile, and providing the encrypted recommendation to the requesting user, wherein the requesting user decrypts it to obtain the recommendation. An equivalent apparatus is configured to perform the method.

### CROSS-REFERENCE TO RELATED APPLICATIONS

This application claims the benefit of and priority to the U.S. Provisional patent applications filed on Aug. 9, 2013: Ser. No. 61/864,088 and titled “A METHOD AND SYSTEM FOR PRIVACY PRESERVING MATRIX FACTORIZATION”; Ser. No. 61/864,085 and titled “A METHOD AND SYSTEM FOR PRIVACY PRESERVING COUNTING”; Ser. No. 61/864,094 and titled “A METHOD AND SYSTEM FOR PRIVACY-PRESERVING RECOMMENDATION TO RATING CONTRIBUTING USERS BASED ON MATRIX FACTORIZATION”; and Ser. No. 61/864,098 and titled “A METHOD AND SYSTEM FOR PRIVACY-PRESERVING RECOMMENDATION BASED ON MATRIX FACTORIZATION AND RIDGE REGRESSION”. In addition, this application claims the benefit of and priority to the PCT Patent Application filed on Dec. 19, 2013, Serial No. PCT/US13/76353 and titled “A METHOD AND SYSTEM FOR PRIVACY PRESERVING COUNTING” and to the U.S. Provisional patent application filed on Mar. 4, 2013: Ser. No. 61/772,404 and titled “PRIVACY-PRESERVING LINEAR AND RIDGE REGRESSION”. The provisional and PCT applications are expressly incorporated by reference herein in their entirety for all purposes.

### TECHNICAL FIELD

The present principles relate to privacy-preserving recommendation systems and secure multi-party computation, and in particular, to providing recommendations to rating contributing users based on matrix factorization, in a privacy-preserving and blind fashion.

### BACKGROUND

A great deal of research and commercial activity in the last decade has led to the wide-spread use of recommendation systems. Such systems offer users personalized recommendations for many kinds of items, such as movies, TV shows, music, books, hotels, restaurants, and more. FIG. 1 illustrates the components of a general recommendation system 100: a number of users 110 representing a Source and a Recomender System (RecSys) 130 which processes the user's inputs 120 and outputs recommendations 140. To receive useful recommendations, users supply substantial personal information about their preferences (users' inputs), trusting that the recommender will manage this data appropriately.

Nevertheless, earlier studies, such as those by B. Mobasher, R. Burke, R. Bhaumik, and C. Williams: “Toward trustworthy recommender systems: An analysis of attack models and algorithm robustness.”, ACM Trans. Internet Techn., 7(4), 2007, and by E. Aimeur, G. Brassard, J. M. Fernandez, and F. S. M. Onana: “ALAMBIC: A privacy-preserving recommender system for electronic commerce”, Int. Journal Inf. Sec., 7(5), 2008, have identified multiple ways in which recommenders can abuse such information or expose the user to privacy threats. Recommenders are often motivated to resell data for a profit, but also to extract information beyond what is intentionally revealed by the user. For example, even records of user preferences typically not perceived as sensitive, such as movie ratings or a person's TV viewing history, can be used to infer a user's political affiliation, gender, etc. The private information that can be inferred from the data in a recommendation system is constantly evolving as new data mining and inference methods are developed, for either malicious or benign purposes. In the extreme, records of user preferences can be used to even uniquely identify a user: A. Naranyan and V. Shmatikov strikingly demonstrated this by de-anonymizing the Netflix dataset in “Robust de-anonymization of large sparse datasets”, in IEEE S&P, 2008. As such, even if the recommender is not malicious, an unintentional leakage of such data makes users susceptible to linkage attacks, that is, an attack which uses one database as auxiliary information to compromise privacy in a different database.

Because one cannot always foresee future inference threats, accidental information leakage, or insider threats (purposeful leakage), it is of interest to build a recommendation system in which users do not reveal their personal data in the clear. A co-pending application by the inventors filed on the same date as this application and titled “A METHOD AND SYSTEM FOR PRIVACY PRESERVING MATRIX FACTORIZARTION” describes a privacy-preserving recommendation system based on matrix factorization. It operates on ratings submitted by users to a recommender system, which profiles the items rates without learning the ratings of individual users or the items they rated. This presumes that the users consent to the recommender learning the item profiles.

The present principles propose a stronger privacy-preserving recommendation system in which the recommender system does not learn any information about the users' ratings and the items that the system has rated, and does not learn any information about the item profiles, or any statiscal information extracted from user data, including the recommendations. Hence, the recommendation system provides recommendations to users who contributed ratings while being completely blind to the recommendations it provides.

### SUMMARY

The present principles propose a method for providing recommendations based on a collaborative filtering technique known as matrix factorization securely, in a privacy-preserving fashion. In particular, the method receives as inputs the ratings users gave to items (e.g., movies, books) and creates a profile for each item and each user that can be subsequently used to predict what rating a user can give to each item. The present principles allow a recommender system based on matrix factorization to perform this task without ever learning the ratings of a user, which item the user has rated, the item profiles or any statiscal information extracted from user data. In particular, the recommendation system provides recommendations to users who contributed ratings, in the form of predictions on how they would rate items that they have not already rated, while being completely blind to the recommendations it provides.

According to one aspect of the present principles, a method for securely generating recommendations through matrix factorization is provided, the method including: receiving a set of records (220), wherein each record is received from a respective user and comprises a set of tokens and a set of items, and wherein each record is kept secret from parties other than its respective user; receiving a request from a requesting user for at least one particular item (330); evaluating the set of records in a Recommender (RecSys) (230) by using a garbled circuit (355) based on matrix factorization, wherein the output of the garbled circuit comprises masked item profiles for the at least one particular item and a masked user profile for the one requesting user; and jointly evaluating the masked item profiles and the masked user profile, among the requesting user, the RecSys and a Crypto-Service Provider (CSP) in order to generate recommendations to the requesting user about the at least one particular item (360-385), wherein each recommendation and user profile for the requesting user is kept secret from parties other than the requesting user and the item profiles for the at least one particular item are kept secret from all parties, and wherein a user profile and an item profile are unmasked versions of the respective masked user profile and masked item profile. The method can further include: designing the garbled circuit in the CSP to perform matrix factorization on the set of records (340), wherein the garbled circuit output comprises masked item profiles for the at least one particular item and a masked user profile for the one requesting user; and transferring the garbled circuit to the RecSys (345). The step of designing in the method can include: designing a matrix factorization operation as a Boolean circuit (3402). The step of designing a matrix factorization circuit can include: constructing an array of the set of records; and performing the operations of sorting (420, 440, 470, 490), copying (430, 450), updating (470, 480), comparing (480) and computing gradient contributions (460) on the array. The method can further include:receiving a set of parameters for the design of the garbled circuit by the CSP, wherein the parameters were sent by the RecSys (335).

According to one aspect of the present principles, the method can further include: encrypting the set of records to create encrypted records (315), wherein the step of encrypting is performed prior to the step of receiving a set of records. The method can further include: generating public encryption keys in the CSP; and sending the keys to the respective users (310). The encryption scheme can be a partially homomorphic encryption (310), and the method can include: masking the encrypted records in the RecSys to create masked records (320); and decrypting the masked records in the CSP to create decrypted-masked records (325). The step of designing (340) includes: unmasking the decrypted-masked records inside the garbled circuit prior to processing them. The method can further include: performing oblivious transfers (350) between the CSP and the RecSys (3502), wherein the RecSys receives the garbled values of the decrypted-masked records and the records are kept private from the RecSys and the CSP.

According to one aspect of the present principles, the step of jointly evaluating can further include: unmasking the masked user profile with a first mask to obtain the user profile (360); encrypting the user profile to create an encrypted user profile (360); calculating in the RecSys a first product of the encrypted user profile and the masked item profile for the at least one particular item (370); calculating in the CSP at least one second product of the encrypted user profile and at least one second mask for the at least one particular item (375); subtracting in the RecSys the at least one second product from the first product to create at least one encrypted recommendation for the at least one particular item (380); and decrypting the at least one encrypted recommendation for the at least one particular item (385). The first mask can be chosen by the requesting user (315) and the at least one second mask can be chosen by the CSP (340). The steps of encrypting and decrypting can use an additively homomorphic encryption scheme chosen by the requesting user (360).

According to one aspect of the present principles, the method can further include: receiving the number of tokens and items of each record (220, 305). Furthermore, the method can further include: padding each record with null entries when the number of tokens of each record is smaller than a value representing a maximum value, in order to create records with a number of tokens equal to said value (3052). The source of the set of records can be a database.

According to one aspect of the present principles, a system for securely generating recommendations through matrix factorization, the system comprising a set of users which will provide a respective set of records, a Crypto-Service Provider (CSP) which will provide a secure matrix factorization circuit and a RecSys which will evaluate the records, such that each record is kept private from parties other than its respective user, wherein each user, the CSP and the RecSys each include: a processor (602), for receiving at least one input/output (604); and at least one memory (606, 608) in signal communication with the processor, wherein the RecSys processor is configured to: receive a set of records, wherein each record comprises a set of tokens and a set of items, and wherein each record is kept secret from parties other than the respective user; receive a request from a requesting user for at least one particular item; evaluate the set of records with a garbled circuit based on matrix factorization, wherein the output of the garbled circuit comprises masked item profiles for the at least one particular item and a masked user profile for the one requesting user; and wherein the requesting user, RecSys and CSP processors are configured to: jointly evaluate the masked item profiles and the masked user profile in order to generate recommendations to the requesting user about the at least one particular item (360-385), wherein each recommendation and user profile for the requesting user is kept secret from parties other than the requesting user, and the item profiles for the at least one particular item are kept secret from all parties and wherein a user profile and an item profile are unmasked versions of the respective masked user profile and masked item profile. The CSP processor in the system can be configured to: design the garbled circuit to perform matrix factorization of the set of records, wherein the garbled circuit output comprises masked item profiles for the at least one particular item and a masked user profile for the one requesting user; and transfer the garbled circuit to the RecSys. The CSP processor in the system can be configured to design the garbled circuit by being configured to: design a matrix factorization operation as a Boolean circuit. The CSP processor in the system can be configured to design the matrix factorization circuit by being configured to: construct an array of the set of records; and perform the operations of sorting, copying, updating, comparing and computing gradient contributions on the array. The CSP processor in the system can be further configured to: receive a set of parameters for the design of the garbled circuit, wherein the parameters were sent by the RecSys.

According to one aspect of the present principles, each user processor can be configured to:encrypt the respective record to create an encrypted record prior to providing the record. The CSP processor can be further configured to: generate public encryption keys in the CSP; and send the keys to the set of users. The encryption scheme can be a partially homomorphic encryption, and wherein the RecSys processor is further configured to:mask the encrypted records to create masked records; and the CSP processor is further configured to:decrypt the masked records to create decrypted-masked records. The CSP processor in the system can be configured to design the garbled circuit by being further configured to: unmask the decrypted-masked records inside the garbled circuit prior to processing them. The RecSys processor and the CSP processor in the system can be further configured to perform oblivious transfers, wherein the RecSys receives the garbled values of the decrypted-masked records and the records are kept private from the RecSys and the CSP.

According to one aspect of the present principles, the requesting user processor can be further configured to: unmask the masked user profile with a first mask to obtain the user profile; encrypt the user profile to create an encrypted user profile; and decrypt at least one encrypted recommendation for the at least one particular item. wherein the RecSys processor is further configured to: calculate a first product of the encrypted user profile and the masked item profile for the at least one particular item; subtract at least one second product from the first product to create at least one encrypted recommendation for the at least one particular item; and wherein the CSP processor is further configured to: calculate in the CSP the at least one second product of the encrypted user profile and at least one second mask for the at least one particular item. The first mask can be chosen by the requesting user and the at least one second mask can be chosen by the CSP. The requesting user processor can be further configured to: use an additively homomorphic encryption scheme chosen by the requesting user.

According to one aspect of the present principles, the RecSys processor in the system can be further configured to: receive the number of tokens of each record, wherein the number of tokens were sent by the Source. Each user processor can be configured to: pad the respective record with null entries when the number of tokens of each record is smaller than a value representing a maximum value, in order to create records with a number of tokens equal to said value. The source of the set of records can be a database.

Additional features and advantages of the present principles will be made apparent from the following detailed description of illustrative embodiments which proceeds with reference to the accompanying figures.

### BRIEF DESCRIPTION OF THE DRAWINGS

The present principles may be better understood in accordance with the following exemplary figures briefly described below

FIG. 1 illustrates the components of a prior art recommendation system;

FIG. 2 illustrates the components of a recommendation system according to the present principles;

FIG. 3 (A, B, C, D) illustrates a flowchart of a privacy-preserving recommendation method according to the present principles;

FIG. 4 (A, B, C) illustrates an exemplary matrix factorization algorithm according to the present principles;

FIG. 5 (A, B) illustrates the data structure S constructed by the matrix factorization algorithm according to the present principles;

FIG. 6 illustrates a block diagram of a computing environment utilized to implement the present principles.

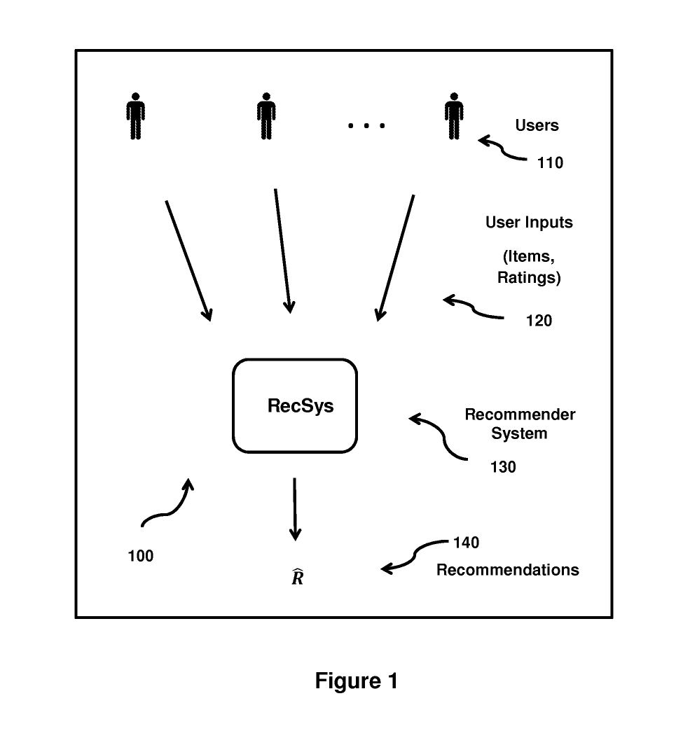

### DETAILED DISCUSSION OF THE EMBODIMENTS

In accordance with the present principles, a method is provided for performing recommendations based on a collaborative filtering technique known as matrix factorization securely, in a privacy-preserving and blind fashion.

The method of the present principles can serve as a service to make a recommendation about an item in a corpus of records, each record comprising a set of tokens and items. The set or records includes more than one record and the set of tokens includes at least one token. A skilled artisan will recognize in the example above that a record could represent a user; the tokens could be a user's ratings to the corresponding items in the record. The tokens can also represent ranks, weights or measures associated with items, and the items can represent persons, tasks or jobs. For example, the ranks, weights or measures can be associated with the health of an individual, and a researcher is trying to correlate the health measures of a population. Or they can be associated with the productivity of an individual and a company is trying to predict schedules for certain jobs, based on prior history. However, to ensure the privacy of the individuals involved, the service wishes to do so in a blind fashion, without learning the contents of each record, the item profiles it provides, or any statiscal information extracted from user data (records). In particular, the service should not learn (a) in which records each token/item appeared or, a fortiori, (b) what tokens/items appear in each record (c) the values of the tokens and (d) the item profiles or any statistical information extracted from user data. In the following, terms and words like “privacy-preserving”, “private” and “secure” are used interchangeably to indicate that the information regarded as private by a user (record) is only known by the user; the word “blind” is used to indicate that parties other than the user are blind to the recommendation as well.

There are several challenges associated with performing matrix factorization in a privacy-preserving way. First, to address the privacy concerns, matrix factorization should be performed without the recommender ever learning the users' ratings, or even which items they have rated. The latter requirement is key: earlier studies show that even knowing which movie a user has rated can be used to infer, e.g., her gender. Second, such a privacy-preserving algorithm ought to be efficient, and scale gracefully (e.g., linearly) with the number of ratings submitted by users. The privacy requirements imply that the matrix factorization algorithm ought to be data-oblivious: its execution ought to not depend on the user input. Moreover, the operations performed by matrix factorization are non-linear; thus it is not a-priori clear how to implement matrix factorization efficiently under both of these constraints. Finally, in a practical, real-world scenario, users have limited communication and computation resources, and should not be expected to remain online after they have supplied their data. Instead it is desirable to have a “send and forget” type solution that can operate in the presence of users that move back and forth between being online and offline from the recommendation service.

As an overview of matrix factorization, in the standard “collaborative filtering” setting, n users rate a subset of m possible items (e.g., movies). For [n]:={1, . . . , n} the set of users, and [m]:={1, . . . , m} the set of items, denote by [symbol] ⊂[n]×[m] the user/item pairs for which a rating has been generated, and by M=[ [symbol] ] the total number of ratings. Finally, for (i, j)∈ [symbol] , denote by r_{i,j}∈ [symbol] the rating generated by user i for item j. In a practical setting, both n and m are large numbers, typically ranging between 10⁴ and 10⁶. In addition, the ratings provided are sparse, that is, M=0(n+m), which is much smaller than the total number of potential ratings n×m. This is consistent with typical user behavior, as each user may rate only a finite number of items (not depending on m, the “catalogue” size).

Given the ratings in [symbol] , a recommender system wishes to predict the ratings for user/item pairs in [n]×[m]\ [symbol] . Matrix factorization performs this task by fitting a bi-linear model on the existing ratings. In particular, for some small dimension d∈ [symbol] , it is assumed that there exist vectors uᵢ∈ [symbol] ^{d}, i∈[n], and vⱼ∈ [symbol] ^{d}, j∈[m], such that

r_{i,j}= [symbol] uᵢ,vⱼ [symbol] +ε_{i,j} (1)

where ε_{i,j} are i.i.d. (independent and identically distributed) Gaussian random variables. The vectors uᵢ and vⱼ are called the user and item profiles, respectively and [symbol] uᵢ, vⱼ [symbol] is the inner product of the vectors. The used notation is U=[uᵢ^{T}]_{i∈[n]}∈ [symbol] ^{n×d} for the n×d matrix whose i-th row comprises the profile of user i, and V=[vⱼ^{T}]_{j∈[m]}∈ [symbol] ^{m×d} for the m×d matrix whose j-th row comprises the profile of item j.

Given the ratings R={r_{i,j}:(i, j)∈ [symbol] }, the recommender typically computes the profiles U and V performing the following regularized least squares minimization:

$${min}_{U , V} \frac{1}{M} {\sum }_{( i , j ) ∈ ℳ} {( {r}_{i , j} - 〈 {u}_{i} {v}_{j} 〉 )}^{2} + λ {\sum }_{i ∈ [ n ]} {‖ {u}_{i} ‖}_{2}^{2} + μ {\sum }_{j ∈ [ m ]} {‖ {v}_{j} ‖}_{2}^{2} \qquad ( 2 )$$

for some positive λ, μ>0. One skilled in the art will recognize that, assuming Gaussian priors on the profiles U and V, the minimization in (2) corresponds to maximum likelihood estimation of U and V. Note that, having the user and item profiles, the recommender can subsequently predict the ratings \hat{R}=\hat{r}_{i,j}: i∈[n], j∈[m]) such that, for user i and item j:

\hat{r}_{i,j}= [symbol] uᵢ,vⱼ [symbol] ,i∈[n],j∈[m] (3)

The regularized mean square error in (2) is not a convex function; several methods for performing this minimization have been proposed in literature. The present principles focus on gradient descent, a popular method used in practice, which is described as follows. Denoting by F(U, V) the regularized mean square error in (2), gradient descent operates by iteratively adapting the profiles U and V through the adaptation rule:

uᵢ(t)=uᵢ(t−1)−γ∇ᵤ_{ᵢ}F(U(t−1),V(t−1))

vᵢ(t)=vᵢ(t−1)−γ∇ᵥ_{ᵢ}F(U(t−1),V(t−1))

where γ>0 is a small gain factor and

$${∇}_{{u}_{i}} F ( U , V ) = - 2 {\sum }_{j : ( i , j ) ∈ ℳ} {v}_{j} ( {r}_{ij} - 〈 {u}_{i} , {v}_{j} 〉 ) + 2 λ {u}_{i} \\ {∇}_{{v}_{j}} F ( U , V ) = - 2 {\sum }_{i : ( i , j ) ∈ ℳ} {u}_{i} ( {r}_{i , j} - 〈 {u}_{i} , {v}_{j} 〉 ) + 2 μ {v}_{j} \qquad ( 5 )$$

where U(0) and V(0) consist of uniformly random norm 1 rows (i.e., profiles are selected u.a.r. (uniformly at random) from the norm 1 ball).

Another aspect of the present principles is proposing a secure multi-party computation (MPC) algorithm for matrix factorization based on sorting networks and Yao's garbled circuits. Secure multi-party computation (MPC) was initially proposed by A. Chi-Chih Yao in the 1980's. Yao's protocol (a.k.a. garbled circuits) is a generic method for secure multi-party computation. In a variant thereof, adapted from “Privacy-preserving Ridge Regression on Hundreds of millions of records”, in IEEE S&P, 2013, by V. Nikolaenko, U. Weinsberg, S. Ioannidis, M. Joye, D. Boneh, and N. Taft, the protocol is run between a set of n input owners, where aᵢ denotes the private input of user i, 1≦i≦n, an Evaluator, that wishes to evaluate ƒ(a₁, . . . , aₙ), and a third party, the Crypto-Service Provider (CSP). At the end of the protocol, the Evaluator learns the value of ƒ(a₁, . . . , aₙ) but no party learns more than what is revealed from this output value. The protocol requires that the function ƒ can be expressed as a Boolean circuit, e.g. as a graph of OR, AND, NOT and XOR gates, and that the Evaluator and the CSP do not collude.

There are recently many frameworks that implement Yao's garbled circuits. A different approach to general purpose MPC is based on secret-sharing schemes and another is based on fully-homomorphic encryption (FHE). Secret-sharing schemes have been proposed for a variety of linear algebra operations, such as solving a linear system, linear regression, and auctions. Secret-sharing requires at least three non-colluding online authorities that equally share the workload of the computation, and communicate over multiple rounds; the computation is secure as long as no two of them collude. Garbled circuits assumes only two noncolluding authorities and far less communication which is better suited to the scenario where the Evaluator is a cloud service and the Crypto-Service Provider (CSP) is implemented in a trusted hardware component.

Regardless of the cryptographic primitive used, the main challenge in building an efficient algorithm for secure multi-party computation is in implementing the algorithm in a data-oblivious fashion, i.e., so that the execution path does not depend on the input. In general, any RAM program executable in bounded time T can be converted to a O(T̂3) Turing machine (TM), which is a theoretical computing machine invented by Alan Turing to serve as an idealized model for mathematical calculation and wherein O(T̂3) means that the complexity is proportional to T³. In addition, any bounded T-time TM can be converted to a circuit of size O(T log T), which is data-oblivious. This implies that any bounded T-time executable RAM program can be converted to a data-oblivious circuit with a O(T̂3 log T) complexity. Such complexity is too high and is prohibitive in most applications. A survey of algorithms for which efficient data-oblivious implementations are unknown can be found in “Secure multi-party computation problems and their applications: A review and open problems”, in New Security Paradigms Workshop, 2001, by W. Du and M. J. Atallah—the matrix factorization problem broadly falls into the category of Data Mining summarization problems.

Sorting networks were originally developed to enable sorting parallelization as well as an efficient hardware implementation. These networks are circuits that sort an input sequence (a₁, a₂, . . . , aₙ) into a monotonically increasing sequence (a′₁, a′₂, . . . , a′ₙ). They are constructed by wiring together compare-and-swap circuits, their main building block. Several works exploit the data-obliviousness of sorting networks for cryptographic purposes. However, encryption is not always enough to ensure privacy. If an adversary can observe your access patterns to encrypted storage, they can still learn sensitive information about what your applications are doing. Oblivious RAM solves this problem by continuously shuffling memory as it is being accessed; thereby completely hiding what data is being accessed or even when it was previously accessed. In oblivious RAM, sorting is used as a means of generating data-oblivious random permutation. More recently, it has been used to perform data-oblivious computations of a convex hull, all-nearest neighbors, and weighted set intersection;

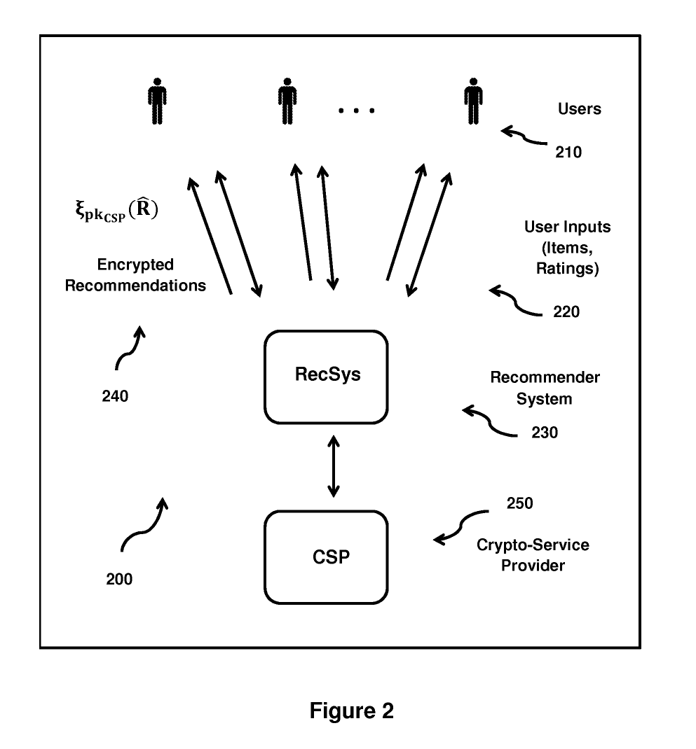

The present principles propose a method based on secure multi-party sorting which is close to weighted set intersection but which incorporates garbled circuits. FIG. 2 depicts the actors in the privacy-preserving recommendation system, according to the present principles. They are as follows:
I. The Recommender System (RecSys) 230, an entity that performs the blind privacy-preserving matrix factorization operation. In particular, the RecSys blindly computes the item profiles V 240, as extracted from matrix factorization on user ratings, without learning anything useful about the users, including which movies they rated, what ratings they gave, or any statistical information (means, item profiles, etc.) extractred from user data, including the recommendations, which are obtained by the users.
II. A Crypto-Service Provider (CSP) 250, that will enable the secure computation without learning anything useful about the users, including which movies they rated, what ratings they gave, or any statistical information (means, item profiles, etc.) extractred from user data, including the recommendations.
III. A Source, consisting of one or more users 210, each having a set of ratings to a set of items 220. Each user i∈[n] consents to the profiling of items based on their ratings r_{i,j}:(i, j)∈ [symbol] through matrix factorization, but do not wish to reveal to the recommender anything, including their ratings, which items they have rated and any statistical information (means, item profiles, etc.) extracted from user data. Equivalently, the Source may represent a database containing the data of one or more users.

According to the present principles, a protocol is proposed that allows the RecSys to execute matrix factorization and provide recommendations, while neither the RecSys nor the CSP learn anything useful about the users, including the recommendations, \hat{R}, given to the users, for which the encrypted values are the outputs of RecSys in FIG. 2. In particular, neither should learn a user's ratings, or even which items the user has actually rated, and neither should learn the item profiles V, the user profiles U, the recommendations, or any statiscal information extracted from user data. A skilled artisan will clearly recognize that a protocol that allows the recommender to learn both user and item profiles reveals too much: in such a design, the recommender can trivially infer a user's ratings from the inner product in (3). As such, the present principles propose a privacy-preserving protocol in which the recommender and the CSP do not learn the user profiles, item profiles or any statistical information extracted from user data. In summary, they perform the operations in a completely blind fashion and do not learn any useful information about the users or extracted from user data.

The item profile can be seen as a metric which defines an item as a function of the ratings of a set of users/records. Similarly, a user profile can be seen as a metric which defines a user as a function of the ratings of a set of users/records. In this sense, an item profile is a measure of approval/disapproval of an item, that is, a reflection of the features or characteristics of an item. And a user profile is a measure of the likes/dislikes of a user, that is, a reflection of the user's personality. If calculated based on a large set of users/records, an item or user profile can be seen as an independent measure of the item or user, respectively. One with skill in the art will realize that there is a utility in learning the item profiles alone. First, the embedding of items in [symbol] ^{d} through matrix factorization allows the recommender to infer (and encode) similarity: items whose profiles have small Euclidean distance are items that are rated similarly by users. As such, the task of learning the item profiles is of interest to the recommender beyond the actual task of recommendations. In particular, the users may not need or wish to receive recommendations, as may be the case if the Source is a database. Second, having obtained the item profiles, there is a trivia: the recommender can use them to provide relevant recommendations without any additional data revelation by users. The recommender can send V to a user (or release it publicly); knowing her ratings per item, user i can infer her (private) profile, uᵢ, by solving (2) with respect to uᵢ; for given V (this is a separable problem), and each user can obtain her profile by performing ridge regression over her ratings. Having uᵢ and V the user can predict all her ratings to other items locally through (4). This is the subject of a co-pending application by the inventors filed on the same date as this application and titled “A METHOD AND SYSTEM FOR PRIVACY-PRESERVING RECOMMENDATION BASED ON MATRIX FACTORIZATION AND RIDGE REGRESSION”.

Both of the scenarios discussed above presume that neither the recommender nor the users object to the public release of V. For the sake of simplicity, as well as on account of the utility of such a protocol to the recommender, a co-pending application by the inventors filed on the same date as this application and titled “A METHOD AND SYSTEM FOR PRIVACY PRESERVING MATRIX FACTORIZATION” allows the recommender to learn the item profiles. The present principles extend this design so that users learn their predicted ratings while the recommender performs the operation in a blind fashion and does not learn any useful information about the users, not even V.

According to the present principles, it is assumed that the security guarantees will hold under the honest but curious threat model. In other words, the RecSys and CSP follow the protocols as prescribed; however, these interested parties may elect to analyze protocol transcripts, even off-line, in order to infer some additional information. It is further assumed that the recommender and CSP do not collude.

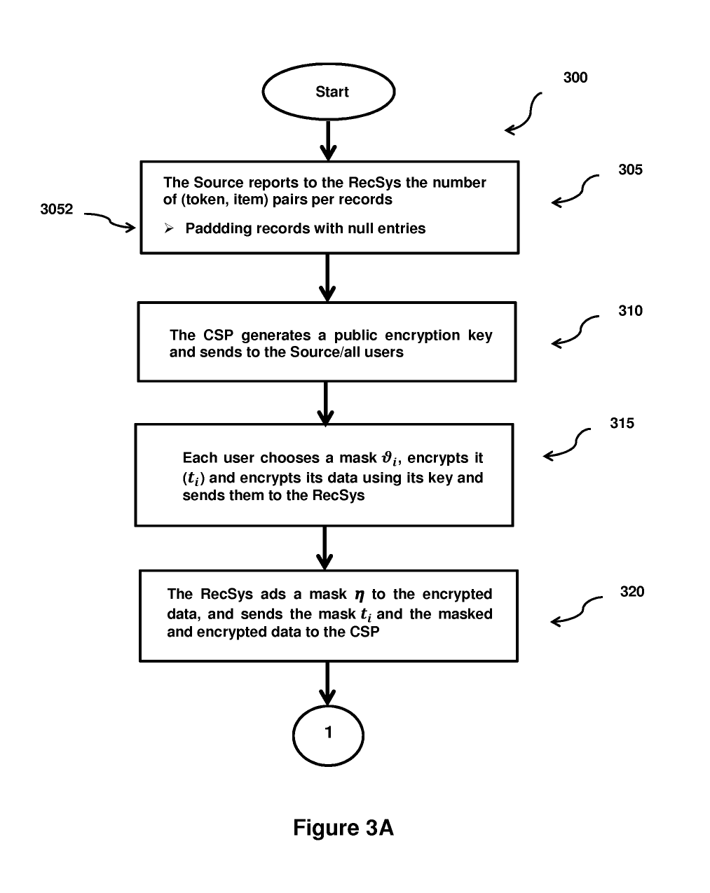

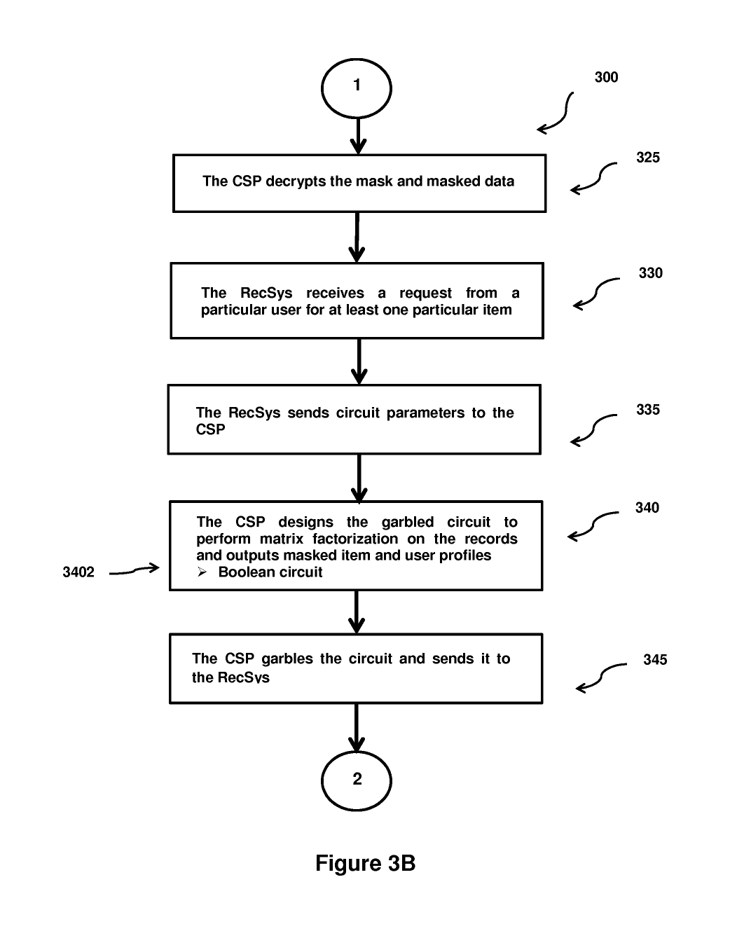

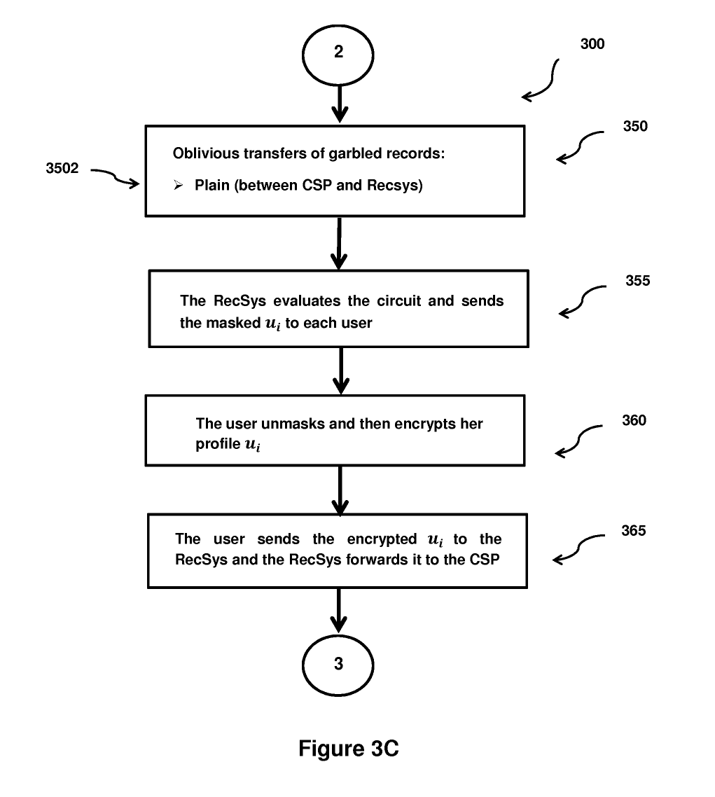

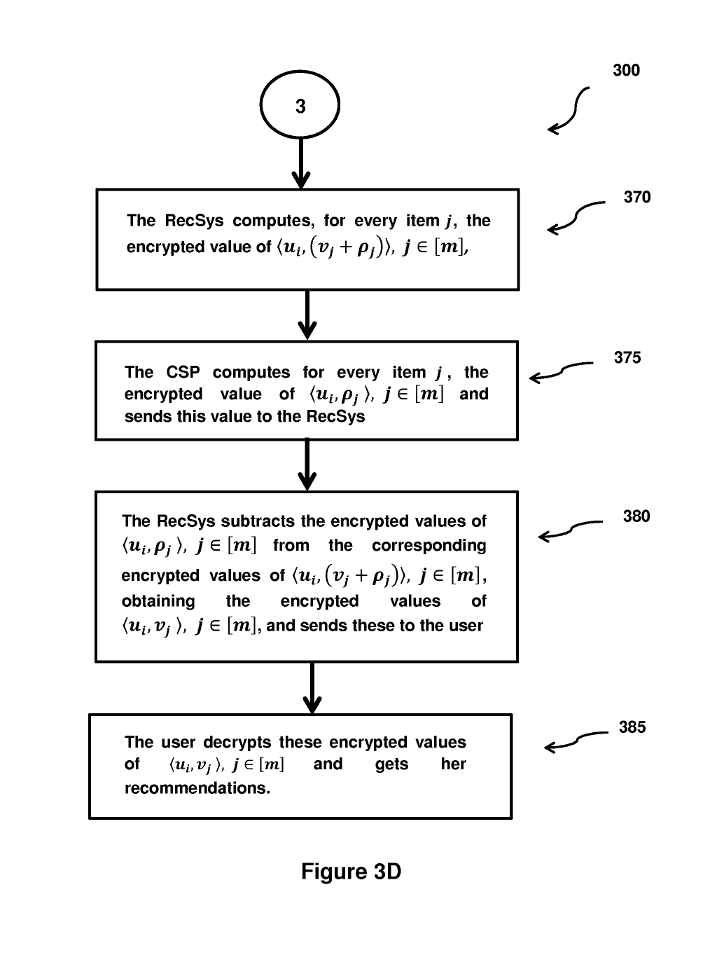

The preferred embodiment of the present principles comprises a protocol satisfying the flowchart 300 in FIG. 3 and described by the following steps:
P1. The Source reports to the RecSys how many pairs of tokens (ratings) and items are going to be submitted for each participating record 305. The set or records includes more than one record and the set of tokens per record includes at least one token. If the Source is a set of users, each user individually reports to the RecSys their respective number of tokens and items.
P2. The CSP generates a public encryption key for a partially homomorphic scheme, ξ and sends it to all users (Source) 310. A skilled artisan will appreciate that homomorphic encryption is a form of encryption which allows specific types of computations to be carried out on ciphertext and obtain an encrypted result which decrypted matches the result of operations performed on the plaintext. For instance, one person could add two encrypted numbers and then another person could decrypt the result, without either of them being able to find the value of the individual numbers. A partially homomorphic encryption is homomorphic with respect to one operation (addition or multiplication) on plaintexts. A partially homomorphic encryption may be homomorphic with respect to addition and multiplication to a scalar.
P3. Each user i chooses a mask θᵢ and encrypts it under the CSP's public key, generating encrypted masks tᵢ. One skilled in the art will understand that a mask is a form of data obfuscation, and could be as simple as adding a random number generator or shuffling by a random number. This mask will be used to hide user i profile uᵢ. In addition, each user encrypts its data using its key. In particular, for every pair (j, r_{i,j}), where j is the item id and r_{i,j} is the rating user i gave to j, the user encrypts this pair using the public encryption key. The users send the encrypted masks tᵢ and the encrypted data to the Recsys 315.
P4. The RecSys adds a mask q to the encrypted data and forwards the encrypted masks tᵢ and the encrypted and masked data to the CSP 320.
P5. The CSP decrypts the encrypted masks tᵢ and retrieves the decrypted masks, and also decrypts the encrypted masked data 325.
P6. The RecSys receives recommendation requests from at least one requesting user for at least one particular item in the corpus of all items (330). Each requesting user is one of the users who contributed records.
P7. The Recsys sends to the CSP the complete specifications needed to build a garbled circuit 335, including the dimension of the user and item profiles (i.e., parameter d) 3352, the total number of ratings (i.e., parameter M) 3354, the total number of users and of items 3356 and the number of bits used to represent the integer and fractional parts of a real number in the garbled circuit 3358. The separate set of items, if not all the items present in the records, will be included in the parameters.
P8. The CSP prepares what is known to the skilled artisan as a garbled circuit that performs matrix factorization 340 on the records with respect to the separate set of items. In order to be garbled, a circuit is first written as a Boolean circuit 3402. The input to the circuit comprises the masks that the RecSys used to mask the user data. Inside the circuit, the mask is used to unmask the data, and then perform matrix factorization. The output of the circuit is V, the item profiles and U, the user profiles. The CSP also chooses its own random masks ρⱼ, one per item j. These will be used to hide the profile of each item j. Rather than outputting the item and user profiles in the clear, the circuit constructed by the CSP outputs (a) the item profiles vⱼ masked with masks ρᵢ, and (b) the user profiles uᵢ masked with masks θᵢ. No knowledge is gained about the contents of any individual record and of any information extracted from the records.
P9. The CSP sends the garbled circuit for matrix factorization to the RecSys 345. Specifically, the CSP processes gates into garbled tables and transmits them to the RecSys in the order defined by circuit structure.
P10. Through oblivious transfer 350 between the RecSys and the CSP 3502, the RecSys learns the garbled values of the decrypted and masked records, without either itself or the CSP learning the actual values. A skilled artisan will understand that an oblivious transfer is a type of transfer in which a sender transfers one of potentially many pieces of information to a receiver, which remains oblivious as to what piece (if any) has been transferred.
P11. The RecSys evaluates the circuit and sends the masked uᵢ to each user i 355, which unmasks it.
P12. If a user wishes to get recommendations, the user unmasks and then encrypts her profile uᵢ 360 using an additively homomorphic encryption scheme, [symbol] , and using her own public key.
P13. The user sends the encrypted uᵢ to the RecSys and the RecSys forwards it to the CSP 365.
P14. The RecSys computes, for every item j, the encrypted value of [symbol] uᵢ, (v₁+ρⱼ) [symbol] , j∈[m] 370, which it can do, as the encryption scheme is additively homomorphic.
P15. The CSP computes for every item j, the encrypted value of [symbol] uᵢ, ρⱼ [symbol] , j∈[m], which it can do, as the encryption scheme is additively homomorphic, and sends this value to the RecSys 375.
P16. The RecSys subtracts the encrypted values of [symbol] uᵢ, ρⱼ [symbol] , j∈[m] from the corresponding encrypted values of [symbol] uᵢ, (vⱼ+ρᵢ) [symbol] , j∈[m], obtaining the encrypted values of [symbol] uᵢ, vⱼ [symbol] , j∈[m], and sends these to the user 380.
P17. The user decrypts these encrypted values of [symbol] uᵢ, vⱼ [symbol] , j∈[m] with the use of her private decryption key, getting thus her predicted rating for every item 385, as shown in equation (3).

The above construction works only for users whose user profiles were computed through matrix factorization. A new user, that has not submitted yet her data, cannot get recommendations this way. Co-pending application Ser. No. ______ and titled “A METHOD AND SYSTEM FOR PRIVACY-PRESERVING RECOMMENDATION BASED ON MATRIX FACTORIZATION AND RIDGE REGRESSION” addresses this particular case.

Technically, this protocol leaks the number of tokens provided by each user, This can be rectified through a simple protocol modification, e.g., by “padding” records submitted with appropriately “null” entries until reaching pre-set maximum number 312. For simplicity, the protocol was described without this “padding” operation.

As garbled circuits can only be used once, any future computation on the same ratings would require the users to re-submit their data through proxy oblivious transfer. A proxy oblivious transfer is an oblivious transfer is which 3 or more parties are involved. For this reason, the protocol of the present principles adopted the hybrid approach, combining public-key encryption with garbled circuits.

In the present principles, public-key encryption is used as follows: Each user i encrypts her respective mask θᵢ under the public key, pk_{CSP}, provided by the CSP with a semantically secure encryption algorithm ξₚₖ_{_{CSP}}, submitting an encrypted mask tᵢ=ξₚₖ_{_{CSP}}(θᵢ). In addition, each user i encrypts her respective inputs (j, r_{i,j}) under the public key, pk_{CSP}, with encryption algorithm ξₚₖ_{_{CSP}}, and, for each item j rated, the user submits a pair (i,c) with c=ξₚₖ_{_{CSP}}(j, r_{i,j}) to the RecSys, where M ratings are submitted in total. A user that submitted her ratings can go off-line.

The CSP public-key encryption algorithm is partially homomorphic: a constant can be applied to an encrypted message without the knowledge of the corresponding decryption key. Clearly, an additively homomorphic scheme such as Paillier or Regev can also be used to add a constant, but hash-ElGamal, which is only partially homomorphic, suffices and can be implemented more efficiently in this case.

Upon receiving M ratings from users—recalling that the encryption is partially homomorphic—the RecSys obscures them with random masks ĉ=c⊕η, where η is a random or pseudo-random variable and ⊕ is an XOR operation. The RecSys sends them to the CSP together with the complete specifications needed to build a garbled circuit. In particular, the RecSys specifies the dimension of the user and item profiles (i.e., parameter d), the total number of ratings (i.e., parameter M), and the total number of users and of items, as well as the number of bits used to represent the integer and fractional parts of a real number in the garbled circuit.

Whenever the RecSys wishes to perform matrix factorization over M accumulated ratings, it reports M to the CSP. The CSP may provide the RecSys with a garbled circuit that (a) decrypts the inputs and then (b) performs matrix factorization. In “Privacy-preserving ridge regression on hundreds of millions of records”, in IEEE S&P, 2013, by V. Nikolaenko, U. Weinsberg, S. Ioannidis, M. Joye, D. Boneh, and N. Taft, decryption within the circuit is avoided by using masks and homomorphic encryption. The present principles utilize this idea to matrix factorization, but only require a partially homomorphic encryption scheme.

Upon receiving the encryptions, the CSP decrypts them and gets the masked values (i, (j, r_{i,j})⊕η). Then, using the matrix factorization as a blueprint, the CSP prepares a Yao's garbled circuit that:
(a) Takes as input the garbled values corresponding to the masks η;
(b) Removes the masks η to recover the corresponding tuples (i, j, r_{i,j});
(c) Performs matrix factorization; and
(d) Outputs the item profiles V=

$${( {v}_{j}^{T} )}_{j ∈ [ m ]}$$

masked with ρⱼ and user profiles masked with θᵢ: \hat{v}ⱼ=vⱼ+ρⱼ, j∈[m] and ûᵢ=uᵢ+θᵢ, i∈[n].

At the end of the of the protocol, the RecSys sends the respective ûᵢ to each user i, who can then recover her profile uᵢ by removing the mask: uᵢ=ûᵢ−θᵢ, i∈[n]. If a user i, wishes to get item recommendations, the user encrypts her profile under her own public key, pkᵢ, with an additively homomorphic encryption algorithm [symbol] ₚₖ_{ᵢ}, (like, for example, Paillier's cryptosystem) and sends the resulting value, [symbol] ₚₖ_{ᵢ}(uᵢ), to the RecSys. The RecSys forwards it to the CSP and also computes, [symbol] ₚₖ_{ᵢ}( [symbol] uᵢ, \hat{v}ᵢ [symbol] ), for j∈[m]. The CSP in turn computes [symbol] ₚₖ_{ᵢ}( [symbol] uᵢ, ρⱼ [symbol] ), for j∈[m], and returns this value to the RecSys. Finally, the RecSys subtracts [symbol] ₚₖ_{ᵢ}( [symbol] uᵢ, ρⱼ [symbol] ) from [symbol] ₚₖ_{ᵢ}( [symbol] uᵢ, \hat{v}ⱼ [symbol] )= [symbol] ₚₖ_{ᵢ}( [symbol] uᵢ,(vⱼ+ρⱼ) [symbol] ) to obtain the encryption of the predicted ratings [symbol] ₚₖ_{ᵢ}(\hat{r}_{i,j})= [symbol] ₚₖ_{ᵢ}( [symbol] uᵢ, vⱼ [symbol] ) for all items j∈[m] and sends them to the user i. The user i can then use her private decryption key to obtain the recommendations in the clear, that is, \hat{r}_{i,1}, \hat{r}_{i,2}, . . . , \hat{r}_{i,m},

The computation of matrix factorization by the gradient descent operations outlined in (4) and (5) involves additions, subtractions and multiplications of real numbers. These operations can be efficiently implemented in a circuit. The K iterations of gradient decent (4) correspond to K circuit “layers”, each computing the new values of profiles from values in the preceding layer. The outputs of the circuit are the item profiles V, while the user profiles are discarded.

One with skill in the art will observe that the time complexity of computing each iteration of gradient descent is O(M), when operations are performed in the clear, e.g., in the RAM model. The computation of each gradient (5) involves adding 2M terms, and profile updates (4) can be performed in O(n+m)=O(M).

The main challenge in implementing gradient descent as a circuit lies in doing so efficiently. To illustrate this, one may consider the following naïve implementation:
Q1. For each pair (i, j)∈[n]×[m], generate a circuit that computes from input the indicators δ_{i,j}=1_{(i, j)∈} [symbol] , which is 1 if i rated j and 0 otherwise.
Q2. At each iteration, using the outputs of these circuits, compute each item and user gradient as a summation over m and n products, respectively, where:

$${∇}_{{u}_{i}} F ( U , V ) = - 2 {\sum }_{j : ( i , j ) ∈ ℳ} {δ}_{i , j} \times {v}_{j} ( {r}_{i , j} - 〈 {u}_{i} , {v}_{j} 〉 ) + 2 λ {u}_{i} \\ {∇}_{{v}_{j}} F ( U , V ) = - 2 {\sum }_{i : ( i , j ) ∈ ℳ} {δ}_{i , j} \times {u}_{i} ( {r}_{i , j} 〈 {u}_{i} , {v}_{j} 〉 ) + 2 μ {v}_{j} \qquad ( 6 )$$

Unfortunately, this implementation is inefficient: every iteration of the gradient descent algorithm will have a circuit complexity of O(n×m). When M<<n×m, as it is usually the case in practice, the above circuit is drastically less efficient than gradient descent in the clear. In fact, the quadratic cost O(n×m) is prohibitive for most datasets. The inefficiency of the naïve implementation arises from the inability to identify which users rate an item and which items are rated by a user at the time of the circuit design, mitigating the ability to leverage the inherent sparsity in the data.

Conversely, according to the preferred embodiment of the present principles, a circuit implementation is provided based on sorting networks whose complexity is O((n+m+M)log²(n+m+M)), i.e., within a polylogarithmic factor of the implementation in the clear.

In summary, both the input data, corresponding to the tuples (i, j, r_{i,j}), and placeholders ⊥ for both the user and item profiles are stored together in an array. Through appropriate sorting operations, user or item profiles can be placed close to the input with which they share an identifier. Linear passes through the data allow the computation of gradients, as well as updates of the profiles. When sorting, the placeholder is treated as +∞, i.e., larger than any other number.

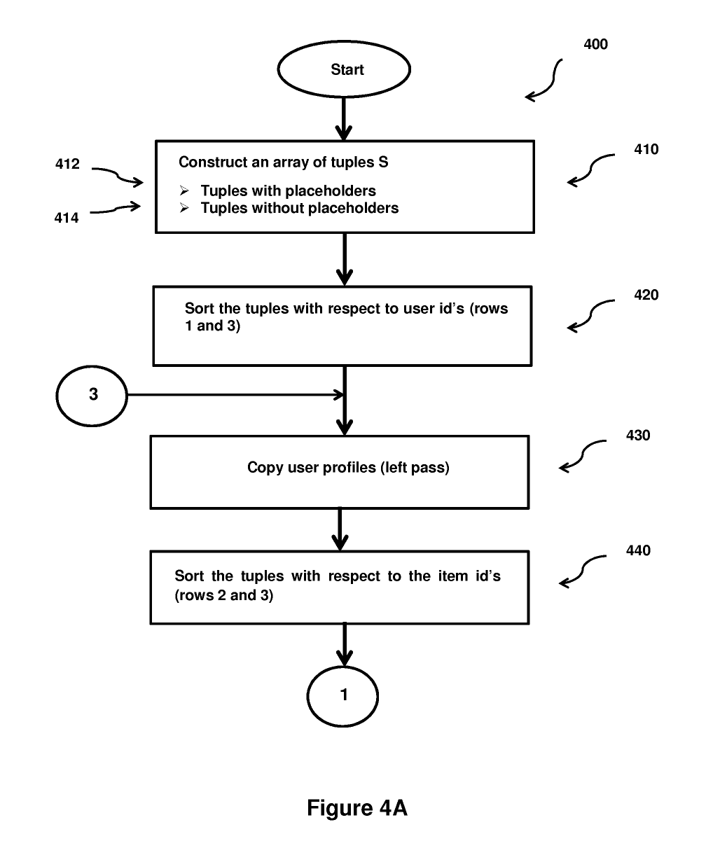

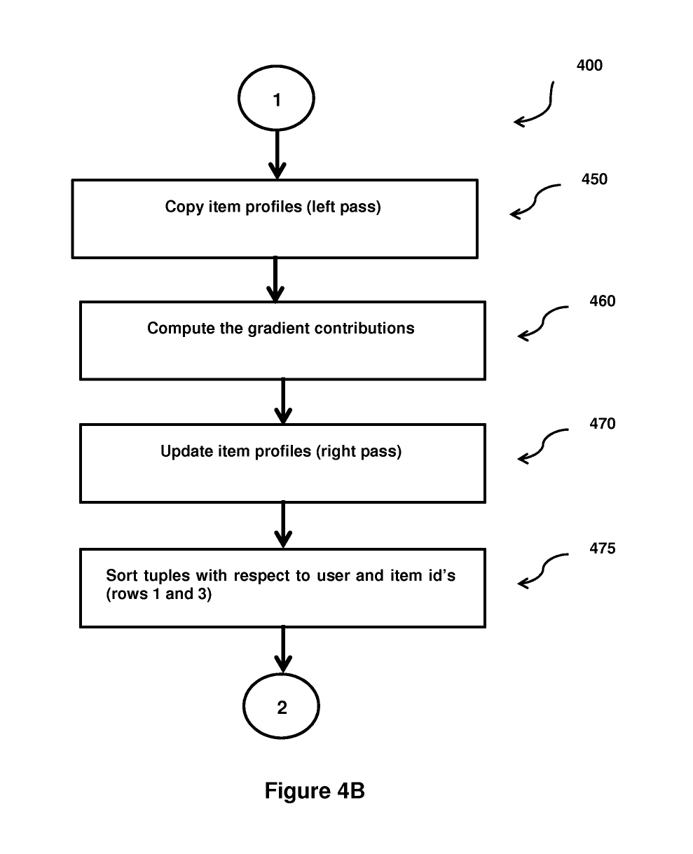

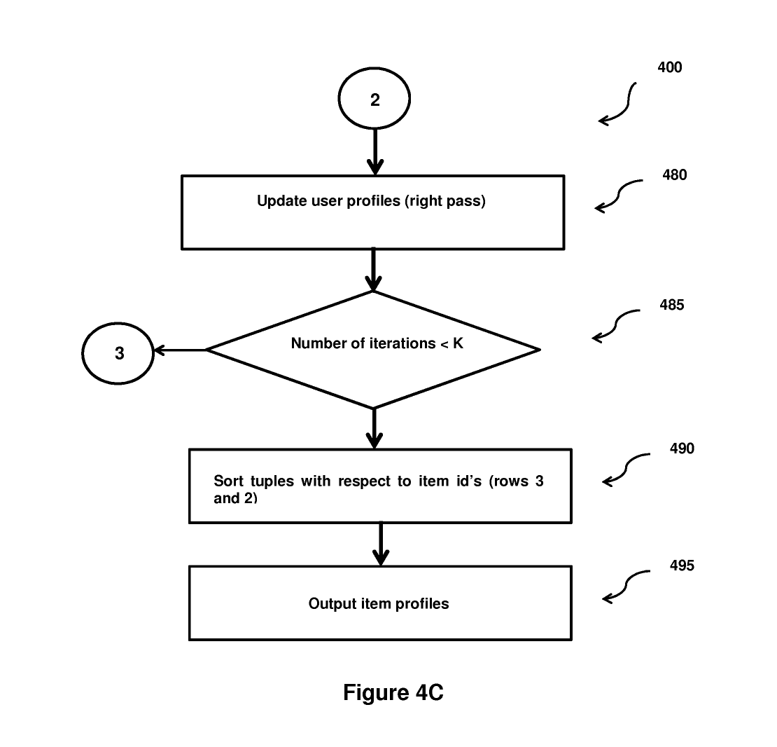

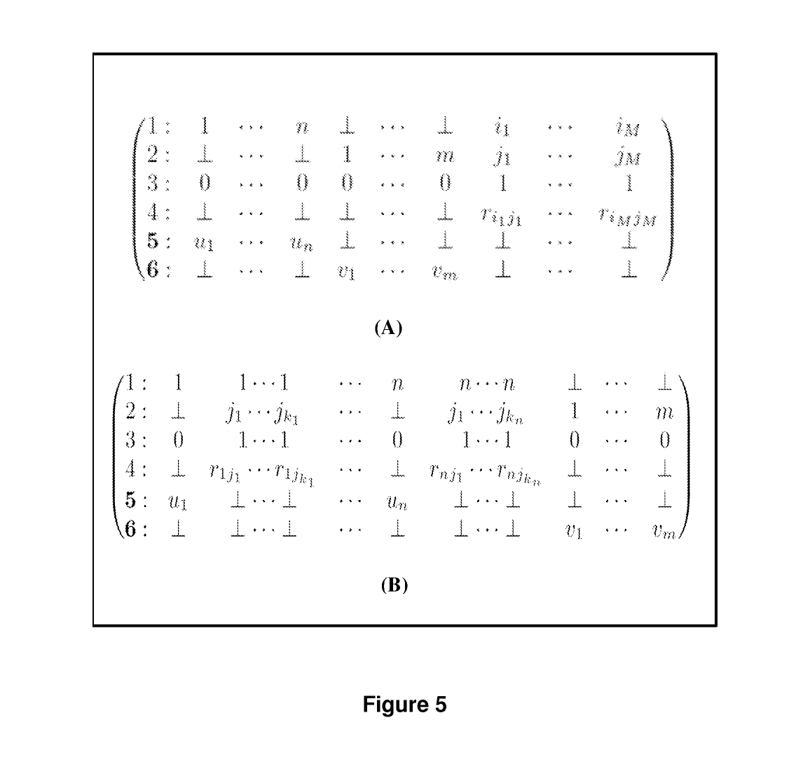

The matrix factorization algorithm according to a preferred embodiment of the present principles and satisfying the flowchart 400 in FIG. 4 can be described by the following steps:
C1. Initialize matrix S 410
   The algorithm receives as input the sets Lᵢ={(j, r_{i,j}):(i, j)∈ [symbol] }, or equivalently, the tuples {(i, j, r_{i,j}):(i, j)∈ [symbol] } and constructs an n+m+M array of tuples. The first n and m tuples of S serve as placeholders for the user and item profiles, respectively, while the remaining M tuples store the inputs Lᵢ. More specifically, for each user i∈[n], the algorithm constructs a tuple (i, ⊥, 0, ⊥, uᵢ, ⊥), where uᵢ∈ [symbol] ^{d} is the initial profile of user i, selected at random. For each item j∈[m], the algorithm constructs the tuple (⊥, j, 0, ⊥, ⊥, vⱼ,™), where vⱼ∈ [symbol] ^{d} is the initial profile of item j, also selected at random. Finally, for each pair (i, j)∈ [symbol] , the algorithm constructs the corresponding tuple (i, j, 1, r_{i,j}, ⊥, ⊥), where r_{i,j} is the rating of user i to item j. The resulting array is as shown in FIG. 5(A). Denoting by s_{l,k} the l-th element of the k-th tuple, these elements serve the following roles:
   (a) s_{1,k}: user identifiers in [n];
   (b) S_{2,k}: item identifiers in [m];
   (C) S_{3,k}: a binary flag indicating if the tuple is a “profile” or “input” tuple;
   (d) S_{4,k}: ratings in “input” tuples;
   (e) s_{5,k}: user profiles in [symbol] ^{d};
   (f) S_{6,k}: item profiles in [symbol] ^{d}.
C2. Sort tuples in increasing order with respect to the user ids (with respect to rows 1 and 3) 420. If two ids are equal, break ties by comparing tuple flags, i.e., the 3rd elements in each tuple. Hence, after sorting, each “user profile” tuple is succeeded by “input” tuples with the same id:
C3. Copy user profiles (left pass) 430:

S_{5,k}←S_{3,k}*S_{5,k-1}+(1−S_{3,k})*s_{5,k}, for k=2, . . . , M+n
C4. Sort tuples in increasing order with respect to item ids (with respect to rows 2 and 3) 440. If two ids are equal, break ties by comparing tuple flags, i.e., the 3rd elements in each tuple.
C5. Copy item profiles (left pass) 450:

s_{6,k}←s_{3,k}*S_{6,k-1}+(1−s_{3,k})*s_{6,k}, for k=2, . . . , M+m
C6. Compute the gradient contributions 460 ∀k<M:

$$⌊ \begin{matrix}{s}_{5 , k} \\ {s}_{6 , k}\end{matrix} ⌋ ← [ \begin{matrix}{s}_{3 , k} * 2 γ {s}_{6 , k} ( {s}_{4 , k} - 〈 {s}_{5 , k} , {s}_{6 , k} 〉 ) + ( 1 - {s}_{3 , k} ) * {s}_{5 , k} \\ {s}_{3 , k} * 2 γ {s}_{5 , k} ( {s}_{4 , k} - 〈 {s}_{5 , k} , {s}_{6 , k} 〉 ) + ( 1 - {s}_{3 , k} ) * {s}_{6 , k}\end{matrix} ] , \\ for ∀ k < M$$

C7. Update item profiles (right pass) 470:

s_{6,k}←s_{6,k}+s_{3,k+1}*s_{6,k+1}+(1−s_{3,k})*2γμs_{6,k}, for k=M+n−1, . . . 1
C8. Sort tuples with respect to rows 1 and 3 475
C9. Update user profiles (right pass) 480:

s_{5,k}←s_{5,k}+s_{3,k+1}*s_{5,k+1}+(1−s_{3,k})*2γλs_{5,k}, for k=M+n−1, . . . 1
C10. If the number of iterations is less than K, goto C3 485
C11. Sort tuples with respect to rows 3 and 2 490
C12. Output item profiles s_{6,k} for k=1, . . . , m, 495, wherein the output may be restricted to at least one item profile.

The gradient descent iterations comprise the following three major steps:
A. Copy profiles: At each iteration, the profiles uᵢ and vⱼ of each respective user i and each item j are copied to the corresponding elements s_{5,k} and S_{6,k} of each “input” tuple in which i and j appear. This is implemented in steps C2 to C5 of the algorithm. To copy, e.g., the user profiles, S is sorted using the user id (i.e., s_{1,k}) as a primary index and the flag (i.e., s_{3,k}) as a secondary index. An example of such a sorting applied to the initial state of S can be found in FIG. 5(B). Subsequently, the user ids are copied by traversing the array from left to right (a “left” pass), as described formally in step C3 of the algorithm. This copies s_{5,k} from each “profile” tuple to its adjacent “input” tuples; item profiles are copied similarly.
B. Compute gradient contributions: After profiles are copied, each “input” tuple corresponding to, e.g., (i, j), stores the rating r_{i,j} (in s_{4,k}) as well as the profiles uᵢ and vⱼ (in s_{5,k} and s_{6,k}, respectively), as computed in the last iteration. From these, the following quantities are computed: vⱼ(r_{i,j}− [symbol] uᵢ, vⱼ [symbol] ) and uᵢ (r_{i,j}− [symbol] uᵢ, vⱼ [symbol] ), which can be seen as the “contribution” of the tuple in the gradients with respect to. uᵢ and v₁, as given by (5). These replace the s_{5,k} and S_{6,k} elements of the tuple, as indicated by step C6 of the algorithm. Through appropriate use of flags, this operation only affects “input” tuples, and leaves “profile” tuples unchanged.
C. Update profiles: Finally, the user and item profiles are updated, as shown in steps C7 to C9 of the algorithm. Through appropriate sorting, “profile” tuples are made again adjacent to the “input” tuples with which they share ids. The updated profiles are computed through a right-to-left traversing of the array (a “right pass”). This operation adds the contributions of the gradients as it traverses “input” tuples. Upon encountering a “profile” tuple, the summed gradient contributions are added to the profile, scaled appropriately. After passing a profile, the summation of gradient contributions restarts from zero, through appropriate use of the flags s_{3,k},s_{3,k+1}.

The above operations are to be repeated K times, that is, the number of desirable iterations of gradient descent. Finally, at the termination of the last iteration, the array is sorted with respect to the flags (i.e., s_{3,k}) as a primary index, and the item ids (i.e., s_{2,k}) as a secondary index. This brings all item profile tuples to the first m positions in the array, from which the item profiles can be outputted. Furthermore, in order to obtain the user profiles, at the termination of the last iteration, the array is sorted with respect to the flags (i.e., s_{3,k}) as a primary index, and the user ids (i.e., s_{1,k}) as a secondary index. This brings all user profile tuples to the first n positions in the array, from which the user profiles can be outputted.

One with skill in the art will recognize that each of the above operations is data-oblivious, and can be implemented as a circuit. Copying and updating profiles requires (n+m+M) gates, so the overall complexity is determined by sorting which, e.g., using Batcher's circuit yields a O((n+m+M)log² (n+m+M)) cost. Sorting and the gradient computation in step C6 of the algorithm are the most computationally intensive operations; fortunately, both are highly parallelizable. In addition, sorting can be further optimized by reusing previously computed comparisons at each iteration. In particular, this circuit can be implemented as a Boolean circuit (e.g., as a graph of OR, AND, NOT and XOR gates), which allows the implementation to be garbled, as previously explained.

According to the present principles, the implementation of the matrix factorization algorithm described above together with the protocol previously described provides a novel method for recommendation, in a privacy-preserving fashion. In addition, this solution yields a circuit with a complexity within a polylogarithmic factor of matrix factorization performed in the clear by using sorting networks. Furthermore, an additional advantage of this implementation is that the garbling and the execution of this circuit are highly parallelizable.

In an implementation of a system according to the present principles, the garbled circuit construction was based on FastGC, a publicly available garbled circuit framework. FastGC is a Java-based open-source framework, which enables circuit definition using elementary XOR, OR and AND gates. Once the circuits are constructed, the framework handles garbling, oblivious transfer and the complete evaluation of the garbled circuit. However, before garbling and executing the circuit, FastGC represents the entire ungarbled circuit in memory as a set of Java objects. These objects incur a significant memory overhead relative to the memory footprint that the ungarbled circuit should introduce, as only a subset of the gates is garbled and/or executed at any point in time. Moreover, although FastGC performs garbling in parallel to the execution process as described above, both operations occur in a sequential fashion: gates are processed one at a time, once their inputs are ready. A skilled artisan will clearly recognize that this implementation is not amenable to parallelization.

As a result, the framework was modified to address these two issues, reducing the memory footprint of FastGC but also enabling parallelized garbling and computation across multiple processors. In particular, we introduced the ability to partition a circuit horizontally into sequential “layers”, each one comprising a set of vertical “slices” that can be executed in parallel. A layer is created in memory only when all its inputs are ready. Once it is garbled and evaluated, the entire layer is removed from memory, and the following layer can be constructed, thus limiting the memory footprint to the size of the largest layer. The execution of a layer is performed using a scheduler that assigns its slices to threads, enabling them to run in parallel. Although parallelization was implemented on a single machine with multiple cores, the implementation can be extended to run across different machines in a straightforward manner since no shared state between slices is assumed.

Finally, to implement the numerical operations outlined in the algorithm, FastGC was extended to support addition and multiplications over the reals with fixed-point number representation, as well as sorting. For sorting, Batcher's sorting network was used. Fixed-point representation introduced a tradeoff between the accuracy loss resulting from truncation and the size of circuit. Furthermore, the implementation of the algorithm was optimized in multiple ways, in particular:
(a) It reduced the cost of sorting by reusing comparisons computed in the beginning of the circuit's execution:
The basic building block of a sorting network is a compare-and-swap circuit, that compares two items and swaps them if necessary, so that the output pair is ordered. The sorting operations (lines C4 and C8) of the matrix factorization algorithm perform identical comparisons between tuples at each of the K gradient descent iterations, using exactly the same inputs per iteration. In fact, each sorting permutes the tuples in array S in exactly the same manner, at each iteration. This property is exploited by performing the comparison operations for each of these sortings only once. In particular, sortings of tuples of the form (i, j, flag, rating) are performed in the beginning of the computation (without the payload of user or item profiles), e.g., with respect to i and the flag first, j and the flag, and back to i and the flag. Subsequently, the outputs of the comparison circuits are reused in each of these sortings as input to the swap circuits used during gradient descent. As a result, the “sorting” network applied at each iteration does not perform any comparisons, but simply permutes tuples (i.e., it is a “permutation” network);
(b) It reduced the size of array S:
Precomputing all comparisons allows us to also drastically reduce the size of tuples in S. To begin with, one with skill in the art can observe that the rows corresponding to user or item ids are only used in matrix factorization algorithm as input to comparisons during sorting. Flags and ratings are used during copy and update phases, but their relative positions are identical at each iteration. Moreover, these positions can be computed as outputs of the sorting of the tuples (i, j, flag, rating) at the beginning of our computation. As such, the “permutation” operations performed at each iteration need only be applied to the user and item profiles; all other rows can be removed from array S. One more improvement reduces the cost of permutations by an additional factor of 2: to fix one set of profiles, e.g., users, and permute only item profiles. Then, item profiles rotate between two states, each one reachable from the other through permutation: one in which they are aligned with user profiles and partial gradients are computed, and one in which item profiles are updated and copied.
(c) It optimized swap operations by using XORs:
Given that XOR operations can be executed for “free”, optimization of comparison, swap, update and copying operations is performed by using XORs wherever possible. One with skilled in the art will appreciate that free-XOR gates can be garbled without the associated garbled tables and the corresponding hashing or symmetric key operations, representing a marked improvement in computation and communication.
(d) It parallelized computations:
Sorting and gradient computations constitute the bulk of the computation in the matrix factorization circuit (copying and updating contribute no more than 3% of the execution time and 0.4% of the non-xor gates); these operations are parallelized through this extension of FastGC. Gradient computations are clearly parallelizable; sorting networks are also highly parallelizable (parallelization is the main motivation behind their development). Moreover, since many of the parallel slices in each sort are identical, the same FastGC objects defining the circuit slices are reused with different inputs, significantly reducing the need to repeatedly create and destroy objects in memory.

It is to be understood that the present principles may be implemented in various forms of hardware, software, firmware, special purpose processors, or a combination thereof. Preferably, the present principles are implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

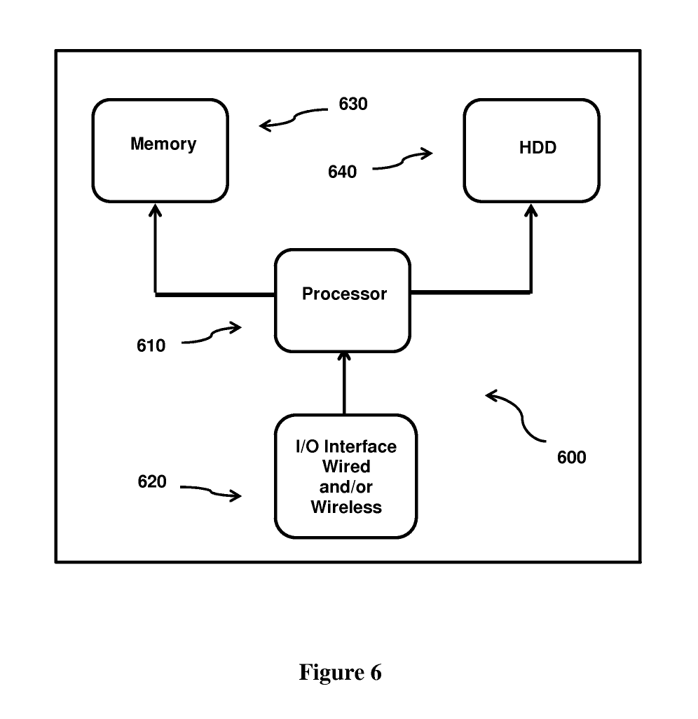

FIG. 6 shows a block diagram of a minimum computing environment 600 used to implement the present principles. The computing environment 600 includes a processor 610, and at least one (and preferably more than one) I/O interface 620. The I/O interface can be wired or wireless and, in the wireless implementation is pre-configured with the appropriate wireless communication protocols to allow the computing environment 600 to operate on a global network (e.g., internet) and communicate with other computers or servers (e.g., cloud based computing or storage servers) so as to enable the present principles to be provided, for example, as a Software as a Service (SAAS) feature remotely provided to end users. One or more memories 630 and/or storage devices (HDD) 640 are also provided within the computing environment 600. The computing environment 600 or a plurality of computer environments 600 may implement the protocol P1-P17 (FIG. 3), for the matrix factorization C1-C12 (FIG. 4) according to one embodiment of the present principles. In particular, in an embodiment of the present principles, a computing environment 600 may implement the RecSys 230; a separate computing environment 600 may implement the CSP 250 and a Source may contain one or a plurality of computer environments 600, each associated with a distinct user 210, including but not limited to desktop computers, cellular phones, smart phones, phone watches, tablet computers, personal digital assistant (PDA), netbooks and laptop computers, used to communicate with the RecSys 230 and the CSP 250. In addition, the CSP 250 can be included in the Source, or equivalently, included in the computer environment of each User 210 of the Source.

It is to be further understood that, because some of the constituent system components and method steps depicted in the accompanying figures are preferably implemented in software, the actual connections between the system components (or the process steps) may differ depending upon the manner in which the present principles are programmed. Given the teachings herein, one of ordinary skill in the related art will be able to contemplate these and similar implementations or configurations of the present principles.

Although the illustrative embodiments have been described herein with reference to the accompanying figures, it is to be understood that the present principles are not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method comprising:
receiving a set of records, wherein each record in the set of records is received from a respective user and comprises a set of tokens and a set of items, and wherein each record is kept secret from parties other than said respective user;
receiving a recommendation request from a requesting user for a particular item;
evaluating said set of records by using a garbled circuit based on matrix factorization, wherein the output of the garbled circuit comprises a masked item profile for a particular item and a masked user profile for said requesting user;
receiving an encrypted user profile from said requesting user;
generating an encrypted recommendation for said particular item based on said encrypted user profile; and
providing said encrypted recommendation to said requesting user, wherein said requesting user decrypts it to obtain said recommendation.

2. The method according to claim 1, further comprising:
receiving the garbled circuit from a crypto-service provider to perform matrix factorization on said set of records, wherein the garbled circuit output comprises the masked item profile for said particular item and the masked user profile for said requesting user.

3. The method according to claim 2, wherein the garbled circuit implements the matrix factorization operation as a Boolean circuit.

4. The method according to claim 3 wherein the garbled circuit constructs an array of said set of records and performs the operations of sorting, copying, updating, comparing and computing gradient contributions on the array.

5. The method according to claim 2, wherein the records are encrypted records.

6. (canceled)

7. The method according to claim 5, wherein the encryption is a partially homomorphic encryption, said method comprising:
masking the encrypted records in the recommender system to create masked records; and
providing the masked records to the crypto-service provider for decryption.

8. The method according to claim 7, wherein the: garbled circuit unmasks the decrypted masked records.

9. The method according to claim 7 further comprising:
performing oblivious transfers between the recommender system and the crypto-service provider, wherein the recommender system receives the garbled values of the decrypted masked records and the records are kept private from the recommender system and the crypto-service provider.

10. The method according to claim 1, wherein generating further comprises:
determining a first multiplication of the encrypted user profile and the masked item profile for the particular item;
receiving a second multiplication of the encrypted user profile and a second mask for the particular item from the crypto-service provider; and
subtracting a second multiplication from the first multiplication to create an encrypted recommendation for the particular item.

11. The method according to claim 1, wherein a first mask for the masked user profile is chosen by the requesting user and a second mask for the masked item profile is chosen by the crypto-service provider.

12. The method according to claim 10, wherein the encrypted user profile and recommendation use an additively homomorphic encryption scheme chosen by the requesting user.

13. The method according to claim 1, further comprising:
receiving a number of tokens and items of each record; and
sending a set of parameters to the crypto-service provider for the implementation of the garbled circuit, wherein the parameters were sent by said recommender system.

14. The method according to claim 1, wherein the records are padded with null entries when the number of tokens of each record is smaller than a maximum value, in order to create records with a number of tokens equal to said maximum value.

15. The method according to claim 1, wherein the source of the set of records can be a database.

16. The method according to claim 2, further comprising:
sending a set of parameters to the crypto-service provider for the implementation of the garbled circuit, wherein the parameters were sent by said recommender system.

17. An apparatus comprising:
a processor that communicates with at least one input/output interface; and
at least one memory in signal communication with said processor, wherein the processor is configured to:
receive a set of records, wherein each record is received from a respective user and comprises a set of tokens and a set of items, and wherein each record is kept secret from parties other than said respective user;
receive a recommendation request from a requesting user for a particular item;
evaluate said set of records with a garbled circuit based on matrix factorization, wherein the output of the garbled circuit comprises a masked item profile for said particular item and a masked user profile for said requesting user;
receive an encrypted user profile from said requesting user;
generate an encrypted recommendation for said particular item based on said encrypted user profile; and
provide said encrypted recommendation to said requesting user, wherein said requesting user decrypts it to obtain said recommendation.

18. The apparatus according to claim 17, wherein the processor is configured to:
receive the garbled circuit from a crypto-service provider to perform matrix factorization of said set of records, wherein the garbled circuit output comprises the masked item profile for said particular item and the masked user profile for said requesting user.

19. The apparatus according to claim 18, wherein the garbled circuit implements the matrix factorization operation as a Boolean circuit.

20. The apparatus according to claim 19 wherein the garbled circuit constructs an array of said set of records and performs the operations of sorting, copying, updating, comparing and computing gradient contributions on the array.

21. The apparatus according to claim 18, wherein the records are encrypted records.

22. (canceled)

23. The apparatus according to claim 21, wherein the encryption is a partially homomorphic encryption, and wherein the processor is further configured to:
mask the encrypted records to create masked records; and
provide the masked records to the crypto-service provider for decryption.

24. The apparatus according to claim 23, wherein the garbled circuit unmasks the decrypted masked records.

25. The apparatus according to claim 23, wherein the processor is further configured to:
perform oblivious transfers with the crypto-service provider, wherein said recommender system receives the garbled values of the decrypted-masked records and the records are kept private from the recommender system and the crypto-service provider.

26. The apparatus according to claim 17, wherein the processor is configured to generate by being further configured to:
determine a first multiplication of the encrypted user profile and the masked item profile for the particular item;
receive a second multiplication from the crypto-service provider; and
subtract said second multiplication from the first multiplication to create an encrypted recommendation for the particular item.

27. The apparatus according to claim 17, wherein a first mask for the masked user profile is chosen by the requesting user and a second mask for the masked item profile is chosen by the crypto-service provider.

28. The apparatus according to claim 26, wherein the encrypted user profile and recommendation use an additively homomorphic encryption scheme chosen by the requesting user.

29. The apparatus according to claim 17, wherein the processor is further configured to:
receive a number of tokens of each record, wherein the number of tokens were sent by said source; and
send a set of parameters for the implementation of the garbled circuit.

30. The apparatus according to claim 17, wherein the records are padded with null entries when the number of tokens of each record is smaller than a maximum value, in order to create records with a number of tokens equal to said maximum value.

31. The apparatus according to claim 17, wherein the source of the set of records can be a database.

32. The apparatus according to claim 18, wherein the processor is further configured to:
send a set of parameters for the implementation of the garbled circuit.

33. A method comprising:
implementing a garbled circuit to perform matrix factorization on a set of records (340), wherein each record is received from a respective user and comprises a set of tokens and a set of items, and each record is kept secret from parties other than said respective user, and wherein the garbled circuit output comprises a masked item profile for a particular item and a masked user profile for a requesting user; and
providing the garbled circuit to a recommender system, wherein said recommender system evaluates said garbled circuit and provides an encrypted recommendation to a requesting user, and said requesting user decrypts it to obtain said recommendation.

34. The method according to claim 33, wherein implementing comprises:
implementing a matrix factorization operation as a Boolean circuit.

35. The method according to claim 34, wherein the garbled circuit performs matrix factorization by constructing an array of said set of records and performing the operations of sorting, copying, updating, comparing and computing gradient contributions on the array.

36. The method according to claim 33, further comprising:
generating public encryption keys; and
sending said keys to said respective users.

37. The method according to claim 36, wherein the encryption is a partially homomorphic encryption, said method further comprising:
receiving masked records from the recommender system; and
decrypting said masked records to create decrypted masked records.

38. The method according to claim 37, wherein implementing comprises:
unmasking the decrypted masked records inside the garbled circuit prior to processing them.

39. The method according to claim 37, further comprising:
performing oblivious transfers with the recommender system, wherein the recommender system receives the garbled values of the decrypted masked records and the records are kept private from the recommender system and the crypto-service provider.

40. The method according to claim 33, further comprising:
receiving an encrypted user profile from the recommender system; and
determining a multiplication of the encrypted user profile and a mask for the particular item;

41. The method according to claim 40, wherein said mask is chosen by the crypto-service provider.

42. An apparatus comprising:
a processor that communicates with at least one input/output; and
at least one memory in signal communication with said processor, wherein the processor is configured to:
implement a garbled circuit to perform matrix factorization on a set of records, wherein each record is received from a respective user and comprises a set of tokens and a set of items, and each record is kept secret from parties other than said respective user, and wherein the garbled circuit output comprises a masked item profile for a particular item and a masked user profile for a requesting user; and
provide the garbled circuit to a recommender system, wherein said recommender system evaluates said garbled circuit and provides an encrypted recommendation to a requesting user, and said requesting user decrypts it to obtain said recommendation.

43. The apparatus according to claim 42, wherein the garbled circuit implements the matrix factorization operation as a Boolean circuit.

44. The apparatus according to claim 43, wherein the garbled circuit performs matrix factorization by constructing an array of said set of records; and performing the operations of sorting, copying, updating, comparing and computing gradient contributions on the array.

45. The apparatus according to claim 42, wherein the processor is further configured to:
generate public encryption keys; and
send said keys to said respective users.

46. The apparatus according to claim 45, wherein the encryption is a partially homomorphic encryption and the processor is further configured to:
receive masked records from the recommender system; and
decrypt said masked records to create decrypted masked records.

47. The apparatus according to claim 46, wherein the processor is configured to implement by being further configured to:
unmask the decrypted masked records inside the garbled circuit prior to processing them.

48. The apparatus according to claim 46, wherein the processor is further configured to:
perform oblivious transfers with the recommender system, wherein the recommender system receives the garbled values of the decrypted-masked records and the records are kept private from the recommender system and the crypto-service provider.

49. The apparatus according to claim 42, wherein the processor is further configured to:
receive an encrypted user profile from the recommender system; and
determine a multiplication of the encrypted user profile and a mask for the particular item.

50. The apparatus according to claim 49, wherein said mask is chosen by the crypto-service provider.

51. A method comprising:
sending a record to a recommender system, wherein a record comprises a set of tokens and a set of items, and is kept secret from parties other than said requesting user;
sending a recommendation request for a particular item; and
decrypting an encrypted recommendation to obtain said recommendation, wherein said encrypted recommendation was generated by a recommender system while evaluating a garbled circuit based on matrix factorization, wherein the output of the garbled circuit comprises a masked item profile for said particular item and a masked user profile for said requesting user.

52. The method according to claim 51, further comprising:
unmasking the masked user profile with a mask to obtain the user profile;
encrypting the user profile to create an encrypted user profile; and
sending said encrypted user profile to the recommender system.

53. The method according to claim 52, further comprising:
selecting the mask.

54. The method according to claim 52, further comprising:
selecting an additively homomorphic encryption scheme for the encrypted user profile and recommendation.

55. An apparatus comprising:
a processor that communicates with at least one input/output interface; and
at least one memory in signal communication with said processor, wherein the processor is configured to:
send a record to a recommender system, wherein a record comprises a set of tokens and a set of items, and is kept secret from parties other than said requesting user;
send a recommendation request for a particular item; and
decrypt an encrypted recommendation to obtain said recommendation, wherein said encrypted recommendation was generated by a recommender system while evaluating a garbled circuit based on matrix factorization, wherein the output of the garbled circuit comprises a masked item profile for said particular item and a masked user profile for said requesting user.

56. The apparatus according to claim 55, wherein the processor is further configured to:
unmask the masked user profile with a mask to obtain the user profile;
encrypt the user profile to create an encrypted user profile; and
send said encrypted user profile to the recommender system.

57. The apparatus according to claim 56, wherein the processor is further configured to:
select the mask.

58. The apparatus according to claim 56, wherein the processor is further configured to:
select an additively homomorphic encryption scheme for the encrypted user profile and recommendation.
